(19) United States
(12) Patent Application Publication
(10) Pub. No.: US 2021/0263360 A1
(43) Pub. Date: Aug. 26, 2021

(54) LIQUID CRYSTAL DISPLAY ELEMENT, MANUFACTURING METHOD OF THE SAME, AND ELECTRONIC DEVICE

(71) Applicants: SONY CORPORATION, TOKYO (JP); SONY SEMICONDUCTOR SOLUTIONS CORPORATION, KANAGAWA (JP)

(72) Inventors: TAKASHI SAKAIRI, KANAGAWA (JP); TOMOAKI HONDA, TOKYO (JP); TAKAAKI TATSUMI, TOKYO (JP)

(21) Appl. No.: 17/250,289

(22) PCT Filed: May 31, 2019
(86) PCT No.: PCT/JP2019/021732

§ 371 Date: Dec. 28, 2020

(30) Foreign Application Priority Data
Jul. 4, 2018 (JP) 2018-127505

(51) Int. Cl. G02F 1/1333; G02F 1/1339; G02F 1/1343; G02F 1/1345

(52) U.S. Cl. CPC G02F 1/13332; G02F 1/133314; G02F 1/1345; G02F 1/1343; G02F 1/1339

(57) ABSTRACT

A liquid crystal display element includes a front panel, a back panel disposed facing the front panel, a liquid crystal material layer held between the front panel and the back panel, and a sealing part that is provided at a position surrounding a periphery of the liquid crystal material layer and establishes electric connection between the front panel and the back panel.

### TECHNICAL FIELD

The present disclosure relates to a liquid crystal display element, a manufacturing method of the same, and an electronic device.

### BACKGROUND ART

In a liquid crystal display element configured by two-dimensionally arranging pixels each of which includes a liquid crystal cell in a matrix, each pixel acts as an optical shutter (light valve) to display an image. As a display device using the liquid crystal display element, a direct viewing type display device and a projection type (projector type) display device have been put in practical use. In recent years, to say nothing of the direct viewing type display device, also in the projection type display device, applications for a large-scale meeting room and for entertainment have been expanding, and high definition and high image quality have been demanded. Therefore, what is called an active matrix type liquid crystal display element has been widely used.

In a transmission type or a reflection type liquid crystal display element such as LCOS (Liquid Crystal On Silicon) and HTPS (High Temperature Poly-Silicon), a liquid crystal material layer is disposed between pixel electrodes and a counter electrode. By applying a voltage between each pixel electrode and the counter electrode, an orientation direction of liquid crystal is changed, thereby displaying an image. The counter electrode is configured with a transparent electrode including, for example, ITO (Indium Tin Oxide) provided on a front panel including a transparent material such as glass. In order to apply the voltage to the counter electrode provided on the front panel, a known method is that the counter electrode provided on the front panel is connected to the feeding electrode provided on the back panel side to which pixel electrodes are provided using an anisotropic conductive film (ACF), in addition to a method in which a feeding electrode is pulled out from the front panel (e.g., refer to PTL 1).

### CITATION LIST

### Patent Literature

### [PTL 1]

Japanese Patent Laid-open No. 2012-195422

### SUMMARY

### Technical Problem

In the method in which the feeding electrode is pulled out from the front panel and the method in which counter electrode provided on the front panel is connected to the feeding electrode provided on the back panel side using the ACF, a space for establishing electric conduction with the counter electrode is required in addition to a sealing part surrounding a liquid crystal material layer. As a result, what is called a bezel part is increased in size. In view of cost reduction, it is preferable that the bezel part is configured as small as possible.

Then, an object of the present disclosure is to provide a liquid crystal display element capable of downsizing a bezel part, a manufacturing method of the liquid crystal display element, and an electronic device provided with the liquid crystal display element.

### Solution to Problem

A liquid crystal display element according to the present disclosure to achieve the above object includes a front panel, a back panel disposed facing the front panel, a liquid crystal material layer held between the front panel and the back panel, and a sealing part provided at a position surrounding a periphery of the liquid crystal material layer and establishing electric connection between the front panel and the back panel.

A manufacturing method of a liquid crystal display element according to the present disclosure to achieve the above object is used for a liquid crystal display element including a front panel, a back panel disposed facing the front panel, and a liquid crystal material layer held between the front panel and the back panel. The manufacturing method includes a step of forming a sealing part provided at a position surrounding a periphery of the liquid crystal material layer and establishing electric connection between the front panel and the back panel, on at least one of the front panel or the back panel, and a step of bonding the front panel and the back panel to each other through the sealing part.

An electronic device according to the present disclosure to achieve the above object includes a liquid crystal display element including a front panel; a back panel disposed facing the front panel; a liquid crystal material layer held between the front panel and the back panel; and a sealing part that surrounds a periphery of the liquid crystal material layer and establishes electric connection between the front panel and the back panel.

### BRIEF DESCRIPTION OF DRAWINGS

FIG. 1 is a schematic diagram for explaining a liquid crystal display element according to a first embodiment of the present disclosure.

FIG. 2 is a schematic diagram for explaining an internal configuration of the liquid crystal display element.

FIG. 3 is a schematic partial sectional view for explaining a structure of a sealing part between a front panel and a back panel in the liquid crystal display element.

FIG. 4 is a schematic plan view for explaining disposition of, for example, pixel electrodes and a feeding electrode in the back panel.

FIG. 5 is a schematic plan view for explaining disposition of pixel electrodes and a feeding electrode in a back panel of a modification.

FIG. 6 is a schematic plan view for explaining disposition of a counter electrode and a sealing part in the front panel.

FIG. 7A and FIG. 7B are schematic partial end surface views for explaining a manufacturing method of the liquid crystal display element according to the first embodiment.

FIG. 8A and FIG. 8B are schematic partial end surface views for explaining the manufacturing method of the liquid crystal display element according to the first embodiment, following FIG. 7B.

FIG. 9A and FIG. 9B are schematic partial end surface views for explaining the manufacturing method of the liquid crystal display element according to the first embodiment, following FIG. 8B.

FIG. 10A and FIG. 10B are schematic partial end surface views for explaining the manufacturing method of the liquid crystal display element according to the first embodiment, following FIG. 9B.

FIG. 11A and FIG. 11B are schematic partial end surface views for explaining the manufacturing method of the liquid crystal display element according to the first embodiment, following FIG. 10B.

FIG. 12A and FIG. 12B are schematic partial end surface views for explaining the manufacturing method of the liquid crystal display element according to the first embodiment, following FIG. 11B.

FIG. 13A and FIG. 13B are schematic partial end surface views for explaining the manufacturing method of the liquid crystal display element according to the first embodiment, following FIG. 12B.

FIG. 14A and FIG. 14B are schematic partial end surface views for explaining a manufacturing method of a liquid crystal display element according to a second embodiment, following FIG. 13B.

FIG. 15A and FIG. 15B are schematic partial end surface views for explaining the manufacturing method of the liquid crystal display element according to the second embodiment.

FIG. 16A and FIG. 16B are schematic partial end surface views for explaining the manufacturing method of the liquid crystal display element according to the second embodiment, following FIG. 15B.

FIG. 17A and FIG. 17B are schematic partial end surface views for explaining the manufacturing method of the liquid crystal display element according to the second embodiment, following FIG. 16B.

FIG. 18A and FIG. 18B are schematic partial end surface views for explaining the manufacturing method of the liquid crystal display element according to the second embodiment, following FIG. 17B.

FIG. 19A and FIG. 19B are schematic partial end surface views for explaining the manufacturing method of the liquid crystal display element according to the second embodiment, following FIG. 18B.

FIG. 20A and FIG. 20B are schematic partial end surface views for explaining the manufacturing method of the liquid crystal display element according to the second embodiment, following FIG. 19B.

FIG. 21 is a schematic partial end surface view for explaining a structure of a sealing part between a front panel and a back panel in a liquid crystal display element according to a third embodiment.

FIG. 22 is a conceptual diagram of a projection type display device.

FIG. 23 is an external appearance view of a digital still camera of a lens interchangeable single lens reflex type, FIG. 23A illustrates a front view of this camera, and FIG. 23B illustrates a rear view of this camera.

FIG. 24 is an external appearance view of a head mounted display.

FIG. 25 is an external appearance view of a see-through head mounted display.

### DESCRIPTION OF EMBODIMENTS

Hereinafter, the present disclosure will be described based on embodiments with reference to the drawings. The present disclosure is not limited to the embodiments, and various numerical values and materials in the embodiments are illustrative. In the following description, an identical reference sign is used for identical elements or components having an identical function, and redundant description will be omitted. Note that the description will be made in the following order.

1. General description of liquid crystal display element, manufacturing method of liquid crystal display element, and electronic device, according to present disclosure

### 2. First Embodiment

### 3. Second Embodiment

### 4. Third Embodiment

5. Description of electronic device and others

### [General Description of Liquid Crystal Display Element, Driving Method of Liquid Crystal Display Element, and Electronic Device, According to Present Disclosure]

In a liquid crystal display element according to the present disclosure, a liquid crystal display element used in an electronic device according to the present disclosure, and a liquid crystal display element that can be obtained with a manufacturing method of a liquid crystal display element according to the present disclosure (hereinafter, those are merely referred to as the present disclosure, in some cases), an aspect can be employed in which a sealing part is configured with a conductive film whose upper surface side is in contact with a front panel and whose lower surface side is in contact with a back panel, and an insulating film that covers an end surface of the conductive film.

The present disclosure having the preferred configuration described above can have a configuration in which the front panel is provided with a counter electrode including a transparent conductive material, and the conductive film configuring the sealing part is disposed to cause an upper surface side of the conductive film to be electrically conducted with the counter electrode.

Alternatively, the present disclosure can employ a configuration in which a feeding electrode that supplies a voltage to the counter electrode is disposed on a surface of the back panel, facing a liquid crystal material layer, and the conductive film configuring the sealing part is disposed to cause a lower surface side of the conductive film to be electrically conducted with the feeding electrode.

The sealing part is formed in a ring shape surrounding the liquid crystal material layer. The feeding electrode may be disposed to be in contact with a part of the ring-shaped sealing part, or may be disposed in a ring shape similar to the sealing part to be in entire contact with the sealing part. In terms of prevention of entering of unnecessary external light toward the back panel, the feeding electrode is preferably provided in the ring shape similar to the sealing part. As a material configuring the feeding electrode or pixel electrodes described later, aluminum (Al), an aluminum alloy such as Al—Cu or Al—Si, and silver (Ag) can be exemplified.

In this case, a configuration can be employed in which the pixel electrodes are disposed on the surface of the back panel, facing the liquid crystal material layer, and the feeding electrode is formed on the same layer as the pixel electrodes.

Alternatively, a configuration can be employed in which the pixel electrodes are disposed on the surface of the back panel, facing the liquid crystal material layer, and the feeding electrode is formed on a different layer from the pixel electrodes.

In this case, drive circuits for driving the pixel electrodes are formed in the back panel, and the feeding electrode is formed in the same layer as a wiring layer used for the drive circuits.

In the present disclosure including various preferred configurations described above, various conductive materials can be used as the conductive film configuring the sealing part. In terms of reliability such as prevention of infiltration of moisture into the liquid crystal material layer, the conductive film configuring the sealing part is preferably configured with a metal material. As the metal material, for example, copper (Cu) and tungsten (W) can be exemplified.

In the present disclosure including various preferred configurations described above, various insulating materials can be used as the insulating film configuring the sealing part. An organic insulating material such as polyimide and an inorganic insulating material such as a silicon oxide and a silicon nitride can be exemplified. For example, in a case of a liquid crystal display element of a projection application, in terms of reliability, the insulating film configuring the sealing part is preferably configured with the inorganic insulating material.

In the present disclosure including various preferred configurations described above, a configuration can be employed in which an opening for injecting a liquid crystal material is formed in the sealing part.

As the front panel, a substrate including a transparent material such as glass can be used. The counter electrode provided on the front panel can be formed using a transparent conductive material such as ITO or IZO. The counter electrode functions as a common electrode for pixels in the liquid crystal display element.

As the back panel, a substrate including a transparent material such as glass and a substrate including a semiconductor material such as silicon can be used. In a case where, for example, the glass substrate is used as the back panel, the drive circuits for driving the pixels can be configured by forming and processing, for example, a semiconductor material layer on the glass substrate. In a case where the substrate including the semiconductor material such as silicon is used, the drive circuits for driving the pixels can be configured by appropriately forming, for example, transistors in wells provided in the substrate.

The liquid crystal display element may be a transmission type, or may be a reflection type. Alternatively, the liquid crystal display element may have a configuration for displaying a monochrome image, or may have a configuration for displaying a color image. As pixel values of the liquid crystal display element, several examples of image resolution can be cited such as (3840, 2160) or (7680, 4320) in addition to U-XGA (1600, 1200), HD-TV (1920, 1080), or Q-XGA (2048, 1536), but the liquid crystal display element is not limited to those values.

Furthermore, as the electronic device provided with the liquid crystal display element of the present disclosure, in addition to the display device of the direct viewing type and the projection type, various types of electronic devices each of which is provided with an image display function can be exemplified.

Various conditions of the present specification can also be satisfied in a case where those are substantially valid, in addition to a case where those are strictly valid. Presence of various variations produced in design or production are allowed. Each of drawings used in the following description is schematic, and does not indicate actual dimensions and a ratio thereof.

### First Embodiment

A first embodiment relates to a liquid crystal display element and a manufacturing method of the liquid crystal display element according to the present disclosure.

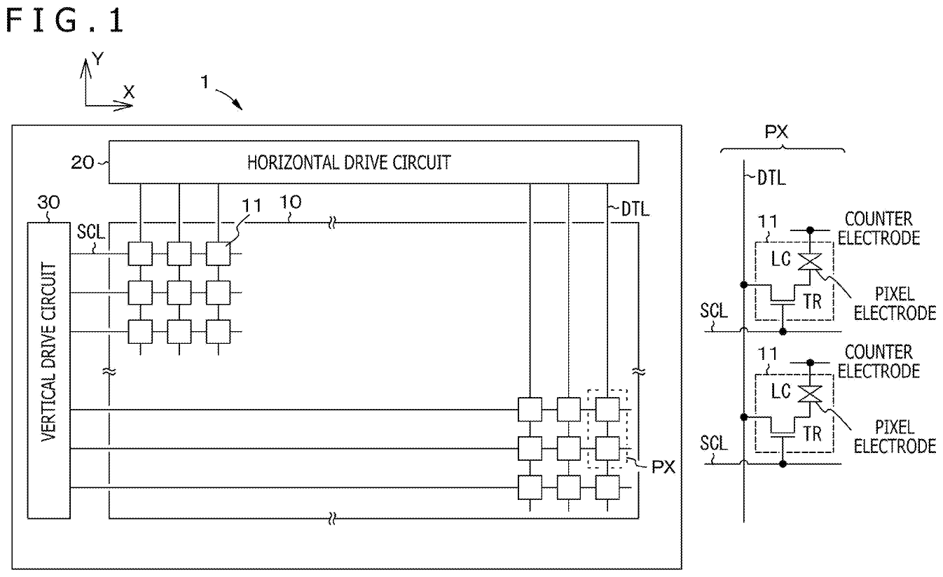

FIG. 1 is a schematic diagram for explaining the liquid crystal display element according to the first embodiment of the present disclosure.

The liquid crystal display element according to the first embodiment is a liquid crystal display element of an active matrix type. As illustrated in FIG. 1, a liquid crystal display element 1 includes various circuits such as a pixel array 10 configured by arranging pixels 11 each of which includes a liquid crystal cell in a matrix, and a horizontal drive circuit 20 and a vertical drive circuit 30 for driving the pixel array 10. Note that, in the example illustrated in FIG. 1, each of the horizontal drive circuit 20 and the vertical drive circuit 30 is disposed on one end side of the pixel array 10, but this configuration is merely exemplification.

The pixel array 10 is configured with, for example, a pair of substrates facing each other and a liquid crystal material layer disposed therebetween, various wirings such as scanning lines SCL and data lines DTL used for driving the pixels 11, pixel electrodes each of which is disposed at a part of a corresponding pixel, a counter electrode facing the pixel electrodes, and pixel transistors that connect the data lines DTL and the pixel electrodes to each other. A connection relationship of two pixels 11 aligned in a vertical direction (a Y-direction in the figure) is schematically illustrated on a right side of the figure. As pixels 11, total M×N pixels configured with M pieces in a horizontal direction and N pieces in the vertical direction are arranged in the matrix.

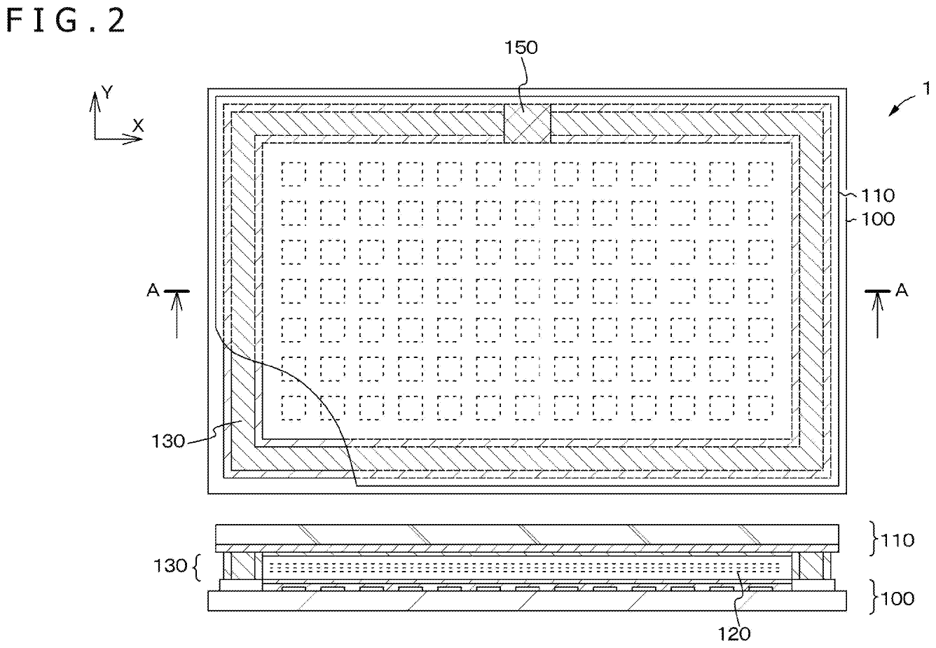

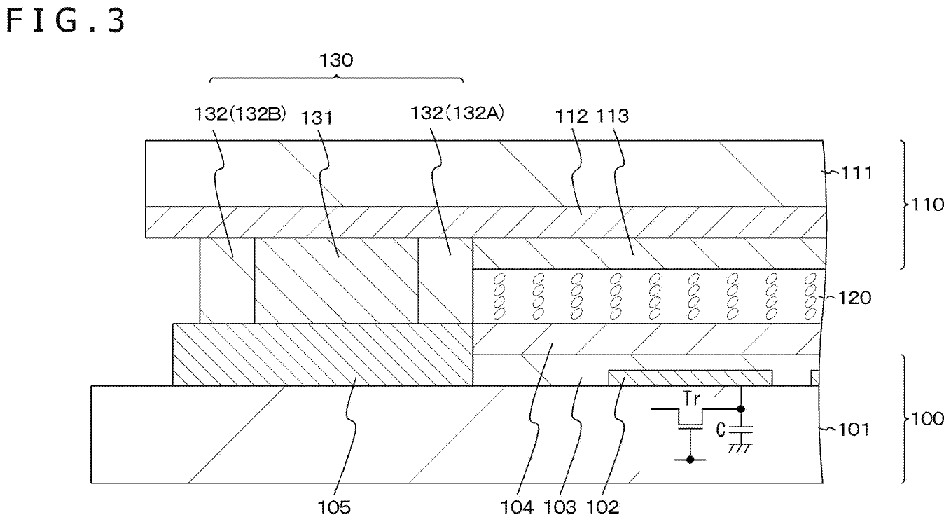

FIG. 2 is a schematic diagram explaining an internal configuration of the liquid crystal display element. Note that, in order to clearly illustrate a lamination relationship, a part of an element is cut out to be illustrated. FIG. 3 is a schematic partial sectional view for explaining a structure of a sealing part between a front panel and a back panel in the liquid crystal display element. Note that, for convenience of illustration, shapes and the like of the components are exaggerated when being illustrated.

As illustrated in FIG. 2, the liquid crystal display element 1 includes a front panel 110, a back panel 100 disposed facing the front panel 110, a liquid crystal material layer 120 held between the front panel 110 and the back panel 100, and a sealing part 130 that is disposed at a position surrounding a periphery of the liquid crystal material layer 120 and establishes electrical connection between the front panel 110 and the back panel 100.

As described later, for example, the back panel 100 is configured with a substrate including a semiconductor material such as silicon. The liquid crystal display element 1 is a reflection type liquid crystal display element.

The sealing part 130 has a ring shape surrounding the liquid crystal material layer 120. Note that the sealing part 130 is formed with an opening for injecting a liquid crystal material, and the opening is sealed after the liquid crystal material is injected. A reference sign 150 indicates a sealing portion of the opening.

As illustrated in FIG. 3, the sealing part 130 is configured with a conductive film 131 whose upper surface side is in contact with the front panel 110 and whose lower surface side is in contact with the back panel 100, and an insulating film 132 that covers end surfaces of the conductive film 131. Note that, in FIG. 3, an insulating film that covers an end surface of the conductive film 131, facing the liquid crystal material layer 120 is denoted with a reference sign 132 (132A), and an insulating film that covers the other end surface of the conductive film 131 is denoted with a reference sign 132 (132B). The conductive film 131 configuring the sealing part 130 is configured with a metal material such as copper (Cu) or tungsten (W). Further, the insulating film 132 configuring the sealing part 130 is configured with an inorganic insulating material such as a silicon oxide or a silicon nitride.

With reference to FIG. 3, electric connection between the front panel 110 and the back panel 100 will be described.

A counter electrode including a transparent conductive material, for example, ITO is provided in the front panel 110. More specifically, the front panel 110 is configured with, for example, a rectangular substrate 111 including, for example, transparent glass, a counter electrode 112 provided on a surface of the substrate 111, facing the liquid crystal material layer 120, and an oriented film 113 provided on the counter electrode 112. The conductive film 131 configuring the sealing part 130 is disposed to cause an upper surface side of the conductive film 131 to be electrically conducted with the counter electrode 112.

The back panel 100 is configured with a rectangular substrate 101 including a semiconductor material, for example, silicon, pixel electrodes 102 disposed on a surface of the back panel 100, facing the liquid crystal material layer 120, a flattening film 103 that covers the pixel electrodes 102, and an oriented film 104 provided on the flattening film 103, for example. Transistors and various wirings that are not illustrated are formed in the substrate 101, and those configure drive circuits that respectively drive the pixel electrodes 102.

Furthermore, on the surface of the back panel 100, facing the liquid crystal material layer 120, a feeding electrode 105 that supplies a voltage to the counter electrode 112 is disposed. In the example illustrated in FIG. 3, the feeding electrode 105 is disposed on the same layer as the pixel electrodes 102. The conductive film 131 configuring the sealing part 130 is disposed to cause a lower surface side of the conductive film 131 to be electrically conducted with the feeding electrode 105.

Accordingly, the front panel 110 and the back panel 100 are electrically connected to each other through the sealing part 130. More specifically, the feeding electrode 105 and the counter electrode 112 are electrically connected to each other through the conductive film 131 configuring the sealing part 130.

Next, a planar disposition relationship of respective elements configuring the back panel 100 and the front panel 110 will be described. Note that, in manufacturing of the liquid crystal display element, employable forms include a form in which the sealing part 130 is provided on the back panel 100 and a form in which the sealing part 130 is provided on the front panel 110. Herein, the form in which the sealing part 130 is provided on the back panel 100 will be described.

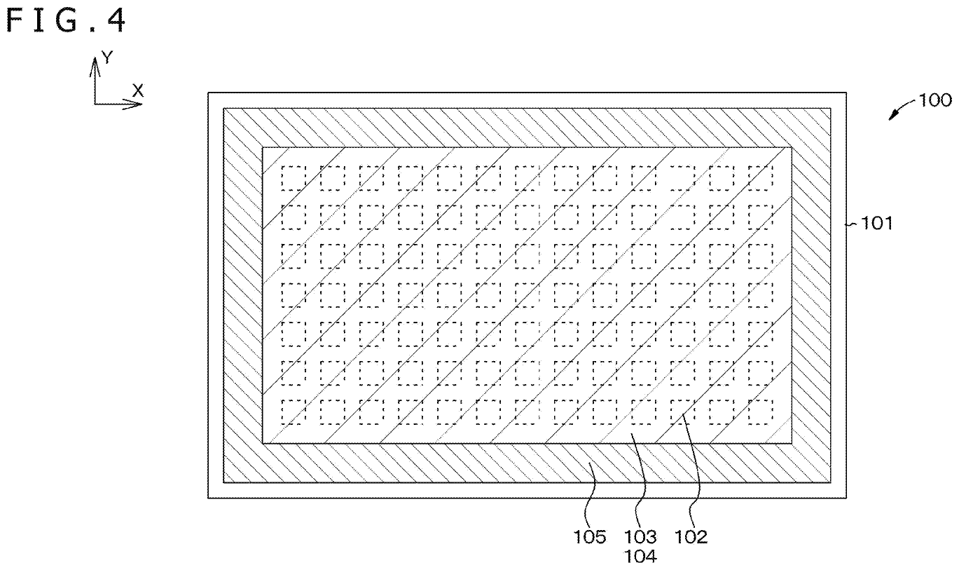

FIG. 4 is a schematic plan view for explaining disposition of, for example, the pixel electrodes and the feeding electrode in the back panel.

The pixel electrodes 102 are arranged such that total M×N pieces configured with M pieces in a horizontal direction and N pieces in the vertical direction are arranged in the matrix so as to respectively correspond the pixels 11. The feeding electrode 105 is disposed in the ring shape so as to surround a periphery of the pixels 11 arranged in the matrix. For example, the pixel electrodes 102 and the feeding electrode 105 include an aluminum alloy such as Al—Cu.

On a region of the pixel electrodes 102 arranged in the matrix, for example, the flattening film 103 including the inorganic insulating material and the oriented film 104 including the inorganic insulating material such as a silicon oxide are sequentially laminated. Those can be formed by a known film formation method or a patterning method. For example, the oriented film 104 can be formed using a vacuum evaporation method having an orientation.

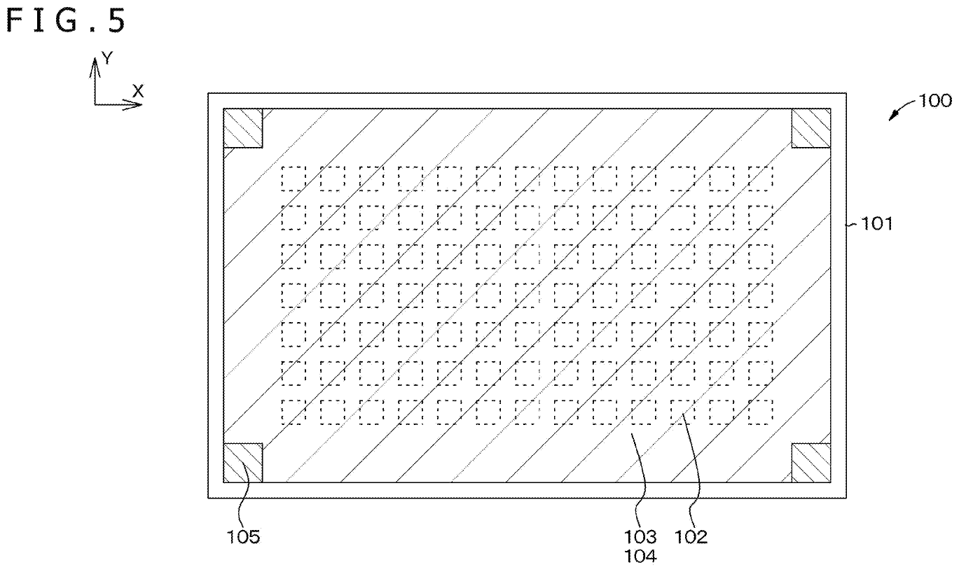

Note that the counter electrode 112 is formed as a common electrode, and therefore, it can be considered that the feeding electrode is not disposed in the ring shape, but is disposed in a discrete manner, in terms of power feeding. FIG. 5 is a schematic plan view for explaining disposition of pixel electrodes and feeding electrodes in a back panel in such a modification. In this example, the feeding electrodes 105 are disposed at four corners of the back panel 100.

The back panel 100 has been described above. Next, a planar disposition relationship of respective components configuring the front panel 110 will be described.

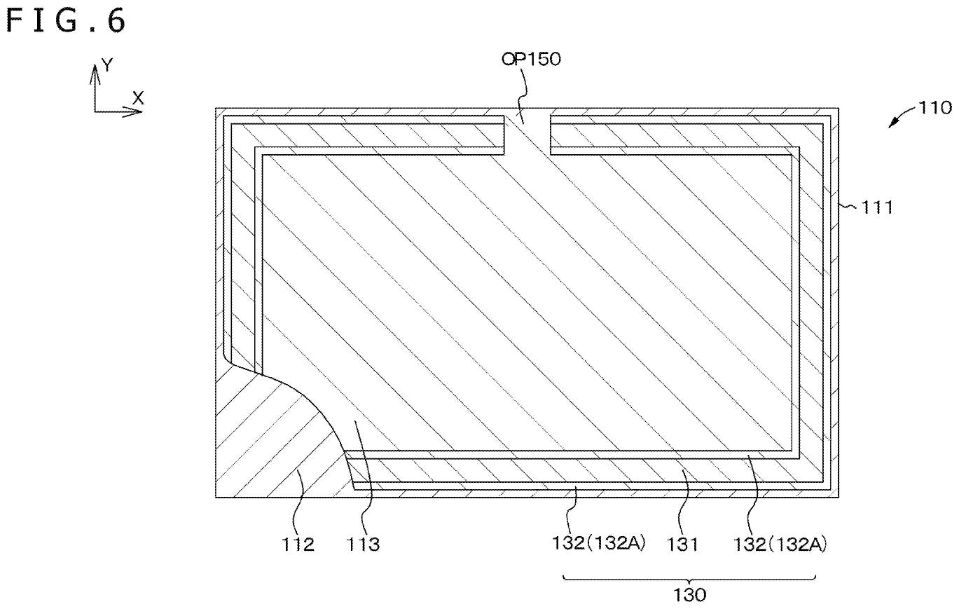

FIG. 6 is a schematic plan view for explaining disposition of the counter electrode and the sealing part in the front panel. Note that, in order to clearly illustrate a lamination relationship, a part of an element is cut out to be illustrated.

The counter electrode 112 is entirely formed on the substrate 111 as the common electrode. The sealing part 130 is disposed at a position surrounding a periphery of the liquid crystal material layer 120. In the sealing part 130, an opening OP150 for injecting the liquid crystal material is formed. In a part of the counter electrode 112 surrounded by the sealing part 130, the oriented film 113 is laminated. Those can be formed by the known film formation method or the patterning method similar to the description of the back panel.

The front panel 110 has been described above. Note that, in a case of the form in which the sealing part is provided on the front panel, a configuration will be employed in which the sealing part 130 illustrated in FIG. 6 is provided on the feeding electrode 105 illustrated in FIG. 4.

Next, a manufacturing method of the liquid crystal display element 1 will be described.

The manufacturing method of the liquid crystal display element 1 includes a step of forming, on at least one of the front panel 110 or the back panel 100, the sealing part 130 that is provided at the position surrounding the periphery of the liquid crystal material layer 120 and establishes electrical connection between the front panel 110 and the back panel 100, and a step of bonding the front panel 110 and the back panel 100 to each other through the sealing part 130. The similar method is applied to other embodiments to be described later.

As described above, the sealing part 130 is configured with the conductive film 131 whose upper surface side is in contact with the front panel 110 and whose lower surface side is in contact with the back panel 100, and the insulating film 132 that covers the end surfaces of the conductive film 131.

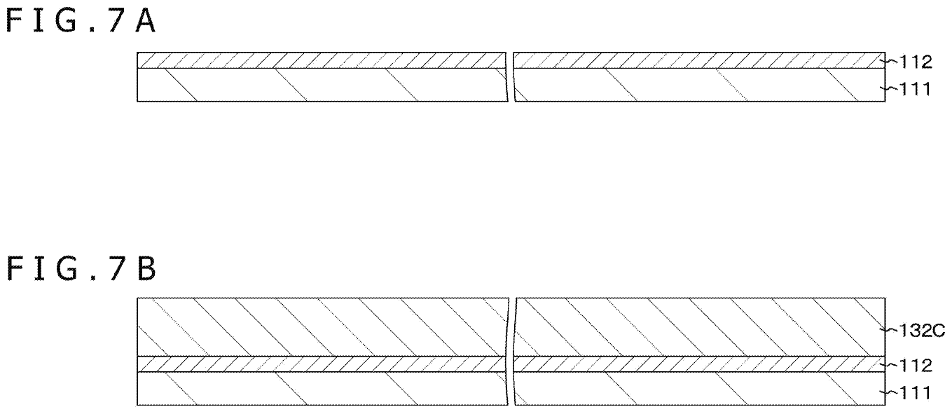

Each of FIG. 7 to FIG. 14 is a schematic partial end surface view for explaining the manufacturing method of the liquid crystal display element according to the first embodiment.

Hereinafter, the manufacturing method of the liquid crystal display element 1 will be described in detail with reference to those drawings.

### [Step-100] (Refer to FIG. 7A and FIG. 7B)

The counter electrode 112 is formed by providing the substrate 111, and performing a predetermined film formation process on the substrate 111 (refer to FIG. 7A). The insulating material layer 132C configuring the insulating film 132 (132A and 132C) in the sealing part 130 is then formed on an entire surface of the counter electrode 112 (refer to FIG. 7B).

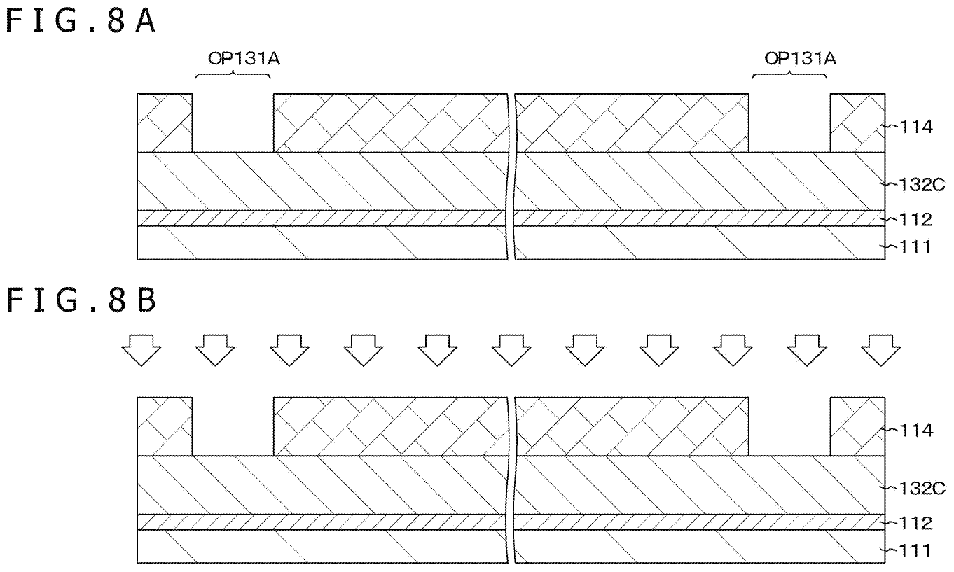

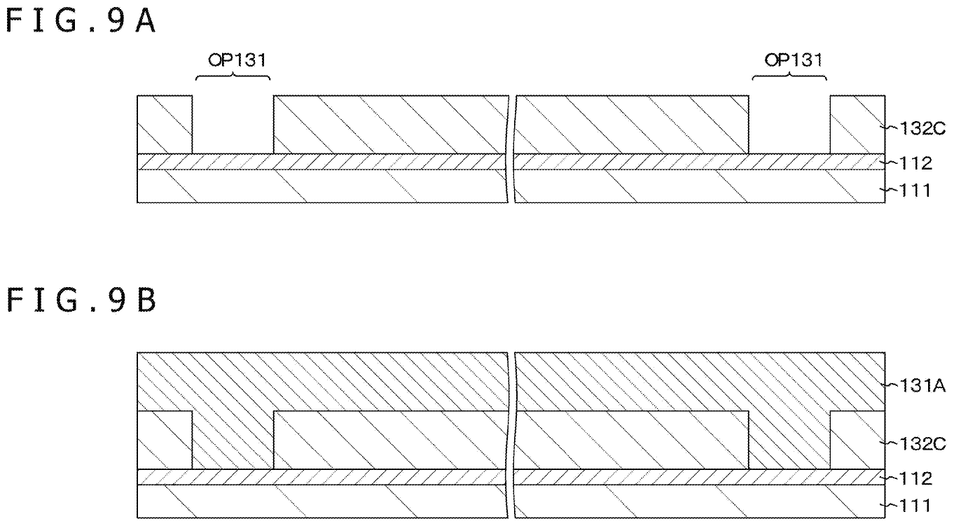

### [Step-110] (Refer to FIG. 8A, FIG. 8B, and FIG. 9A)

Next, a mask layer 114 having an opening at a part on which the conductive film 131 is to be disposed is formed on the insulating material layer 132C. A reference sign OP131A indicates the opening at the part on which the conductive film 131 is to be disposed (refer to FIG. 8A). For example, a dry etching method is then performed (refer to FIG. 8B) to form an opening OP131 in the insulating material layer 132C, and then the mask layer 114 is removed (refer to FIG. 9A).

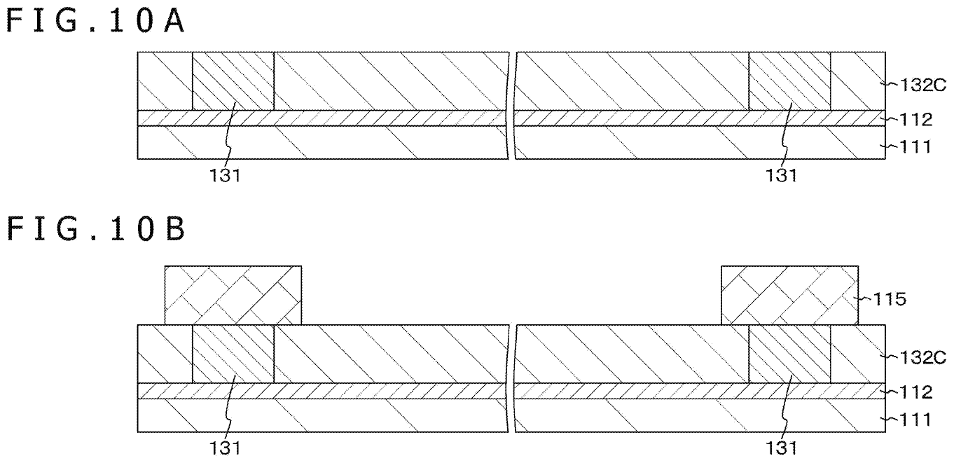

### [Step-120] (Refer to FIG. 9B and FIG. 10A)

Next, a conductive material layer 131A configuring the conductive film 131 in the sealing part 130 is formed on an entire surface of the insulating material layer 132C including the opening OP131 (refer to FIG. 9B). Flattening is then performed by, for example, CMP to form the conductive film 131 embedded in the opening of the insulating material layer 132C (refer to FIG. 10A).

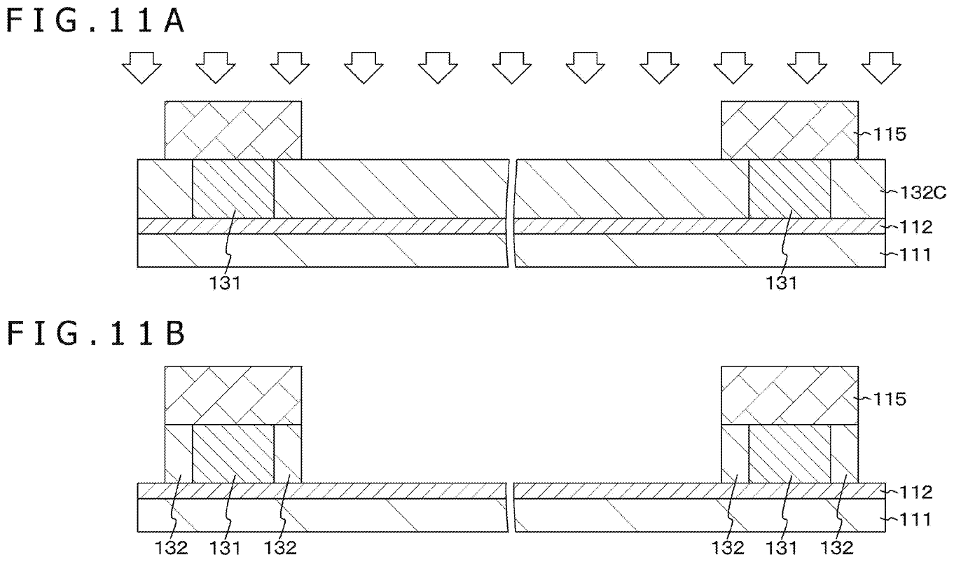

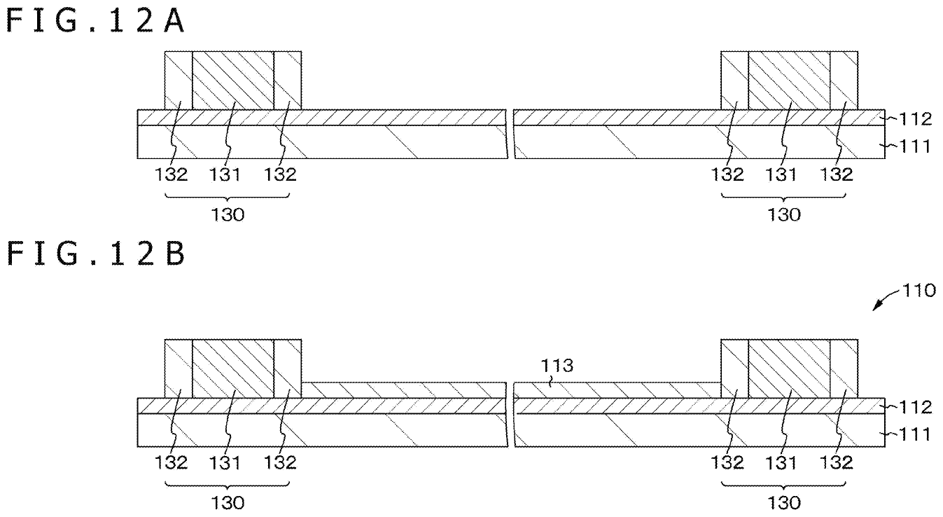

### [Step-130] (Refer to FIG. 10B, FIG. 11A, FIG. 11B, and FIG. 12A)

Next, a mask layer 115 is formed so as to cover a part at which the sealing part 130 is to be provided (refer to FIG. 10B). For example, the dry etching method is then performed (refer to FIG. 11A), to remove an unnecessary part of the insulating material layer 132C (refer to FIG. 11B). The mask layer 115 is then removed (refer to FIG. 12A).

### [Step-140] (Refer to FIG. 12B)

Next, the oriented film 113 is formed on a part of the counter electrode 112 surrounded by the sealing part 130. Through a series of steps described above, the front panel 110 formed with the sealing part 130 can be obtained.

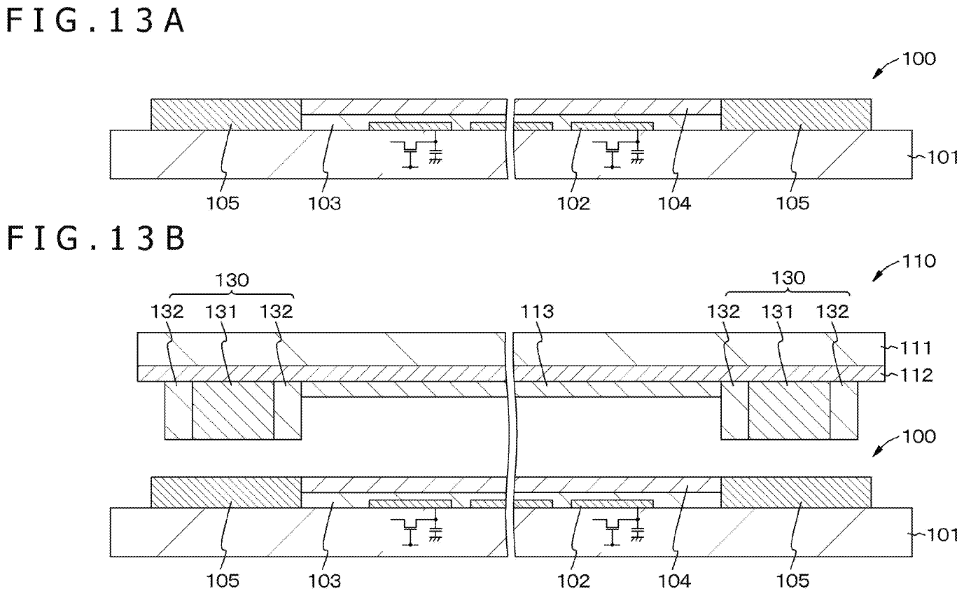

### [Step-150] (Refer to FIG. 13A)

The substrate 101 formed with the drive circuits is provided, and the pixel electrodes 102, the flattening film 103, the oriented film 104, and the feeding electrode 105 are formed on the substrate 101 by the known film formation method or the patterning method. With this operation, the back panel 100 formed with the feeding electrode 105 can be obtained.

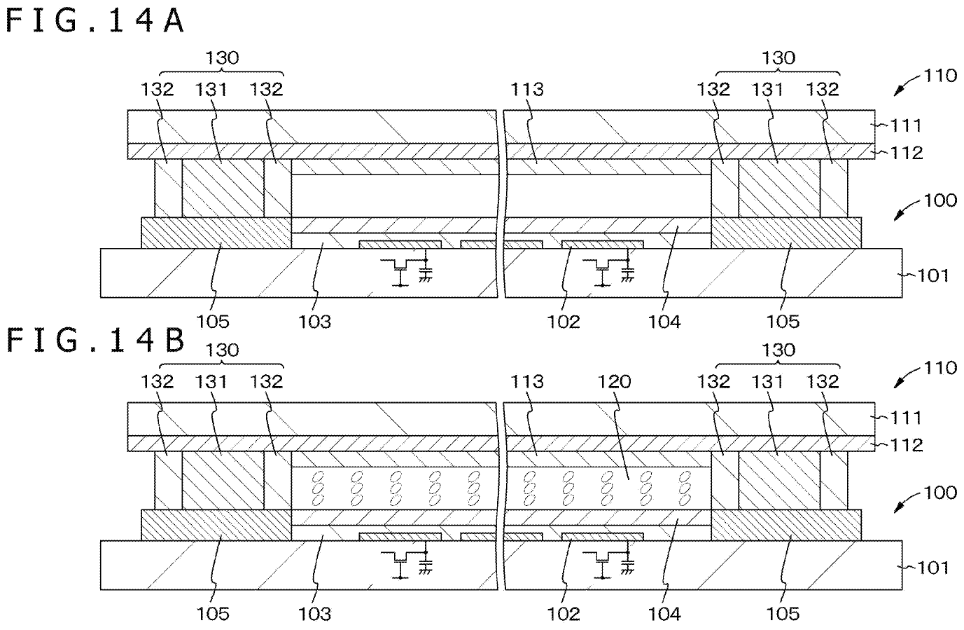

### [Step-160] (Refer to FIGS. 13B, 14A, and 14B)

Next, in a state in which the front panel 110 and the back panel 100 are caused to face each other through the sealing part 130 (refer to FIG. 13B), for example, a surface of the connection electrode 105 and a surface of the facing sealing part 130 are activated under ultrahigh vacuum, and those surfaces are brought into close contact with each other, whereby the front panel 110 and the back panel 100 are bonded to each other (refer to FIG. 14A). Next, a liquid crystal material is injected into a gap between the front panel 110 and the back panel 100, and then the liquid crystal material is sealed as appropriate (refer to FIG. 14B).

Through a series of steps described above, the liquid crystal display element 1 can be obtained.

The liquid crystal display element 1 does not need a space for establishing electric conduction with the counter electrode in addition to the sealing part surrounding the liquid crystal material layer. This can reduce in size of what is called a bezel part. Therefore, the liquid crystal display element 1 can be downsized, whereby cost reduction can be achieved.

In addition, the sealing part 130 is formed by the film formation process, whereby a thickness thereof can be controlled with high accuracy. This also provides an advantage in which a facing distance between the front panel 110 and the back panel 100 can be regulated with high accuracy.

In addition, the conductive film 131 can be configured using the metal material, whereby infiltration of moisture can also be effectively prevented, and reliability of the liquid crystal display element can also be improved.

### Second Embodiment

A second embodiment relates to a manufacturing method of the liquid crystal display element according to the present disclosure.

In the manufacturing method of the liquid crystal display element according to the first embodiment, the configuration has been described in which the sealing part is formed on the front panel, and then the front panel and the back panel are bonded to each other. In contrast, in the second embodiment, the sealing part is formed on the back panel, and then the front panel and the back panel are bonded to each other.

A configuration of the liquid crystal display element obtained by the manufacturing method according to the second embodiment is similar to that of the liquid crystal display element 1 described in the first embodiment, thereby omitting description.

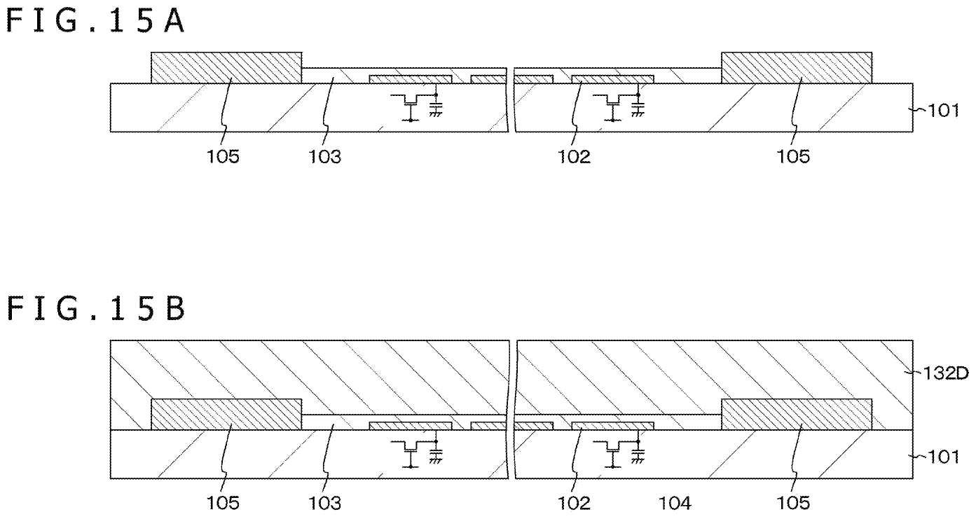

Each of FIG. 15 to FIG. 20 is a schematic partial end surface view for explaining the manufacturing method of the liquid crystal display element according to the second embodiment.

Hereinafter, the manufacturing method of the liquid crystal display element 1 will be described in detail with reference to those drawings.

### [Step-200] (Refer to FIG. 15A)

The substrate 101 formed with the drive circuits is provided, and the pixel electrodes 102, the flattening film 103, and the feeding electrode 105 are formed on the substrate 101 by the known film formation method or the patterning method.

### [Step-210] (Refer to FIG. 15B)

Next, an insulating material layer 132D configuring the insulating film 132 (132A and 132C) in the sealing part 130 is then formed on an entire surface of the substrate 101 (refer to FIG. 7B).

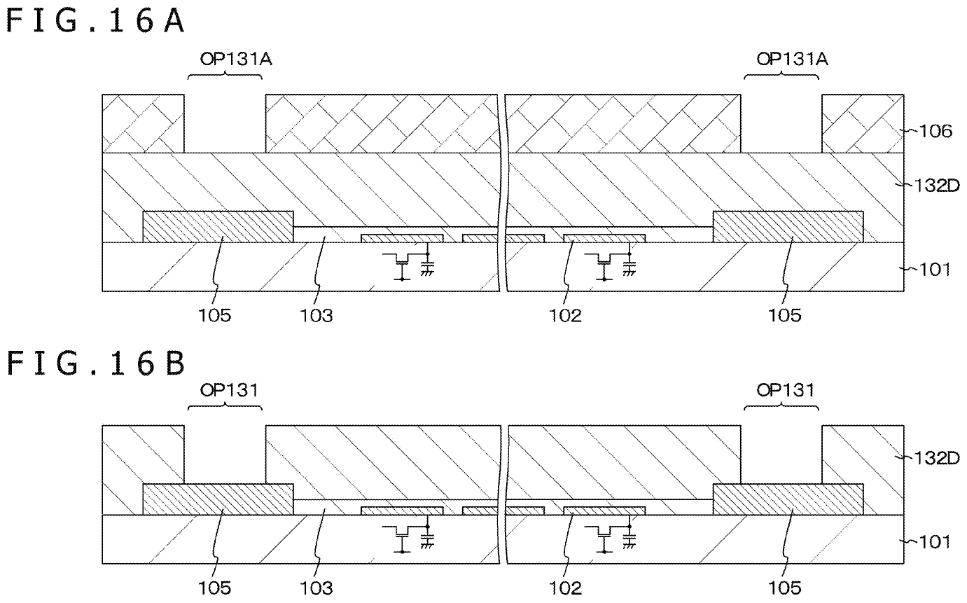

### [Step-220] (Refer to FIG. 16A and FIG. 16B)

Next, a mask layer 106 having an opening at a part on which the conductive film 131 is to be disposed on the insulating material layer 132D. A reference sign OP131A indicates the opening at the part on which the conductive film 131 is to be disposed (refer to FIG. 16A). For example, a dry etching method is then performed to form an opening OP131 in the insulating material layer 132C, and the mask layer 106 is then removed (refer to FIG. 16B).

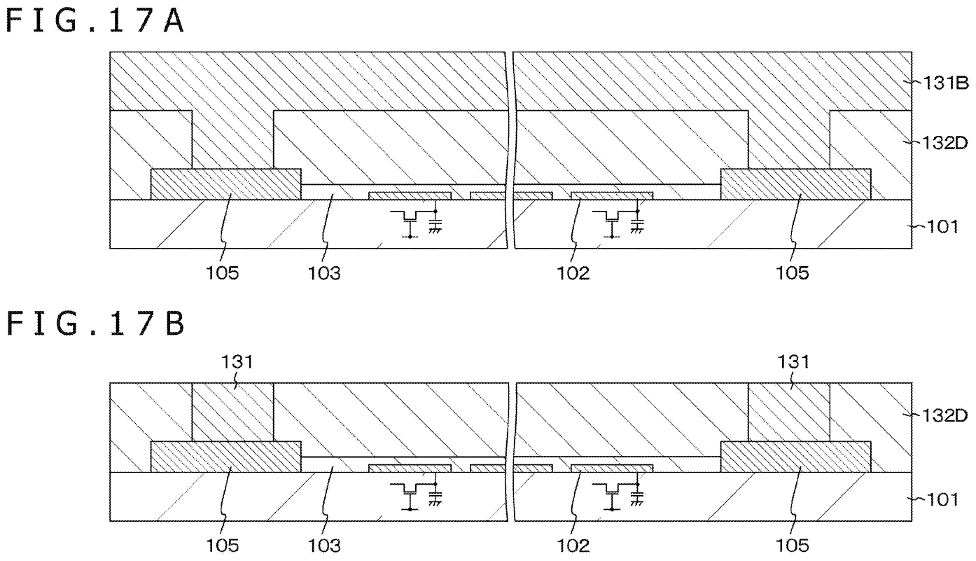

### [Step-230] (Refer to FIG. 17A and FIG. 17B)

Next, a conductive material layer 131B configuring the conductive film 131 in the sealing part 130 is formed on an entire surface of the insulating material layer 132D including the opening OP131 (refer to FIG. 17A). Flattening is then performed by, for example, the CMP to form the conductive film 131 embedded in the opening of the insulating material layer 132D (refer to FIG. 17B).

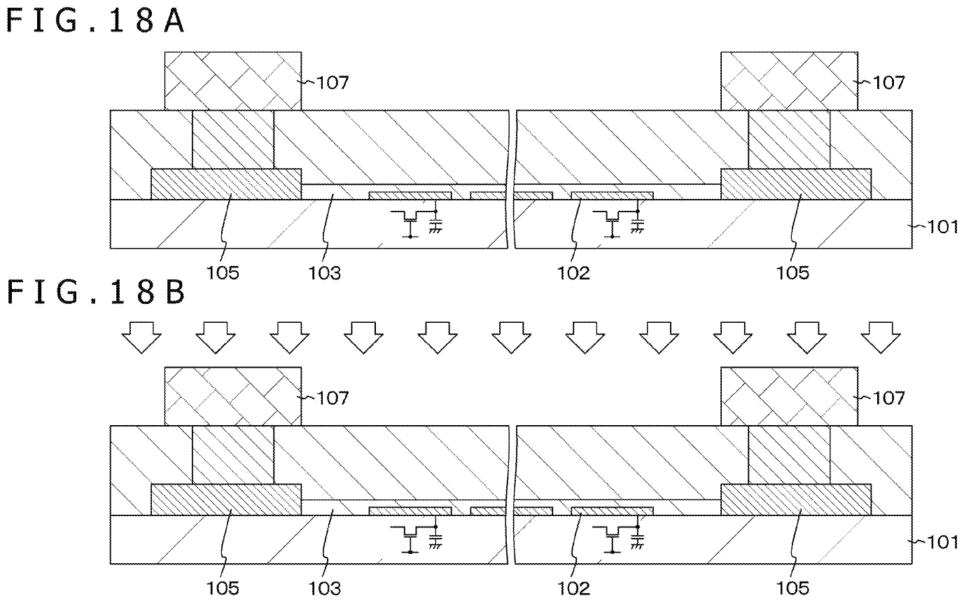

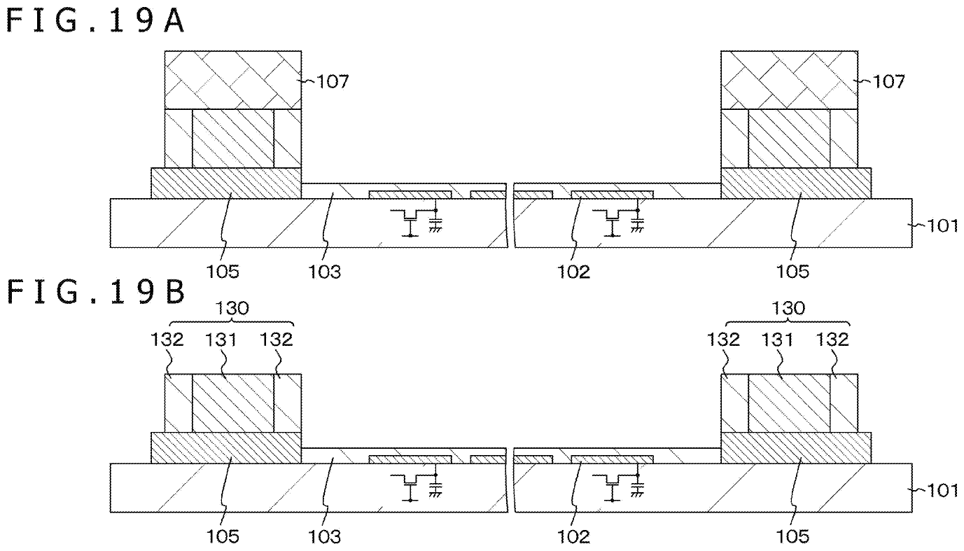

### [Step-240] (Refer to FIG. 18A, FIG. 18B, FIG. 19A, and FIG. 19B)

Next, a mask layer 107 is formed so as to cover a part at which the sealing part 130 is to be provided (refer to FIG. 18A). For example, the dry etching method is then performed (refer to FIG. 18B), to remove an unnecessary part of the insulating material layer 132D (refer to FIG. 19A). The mask layer 107 is then removed (refer to FIG. 19B).

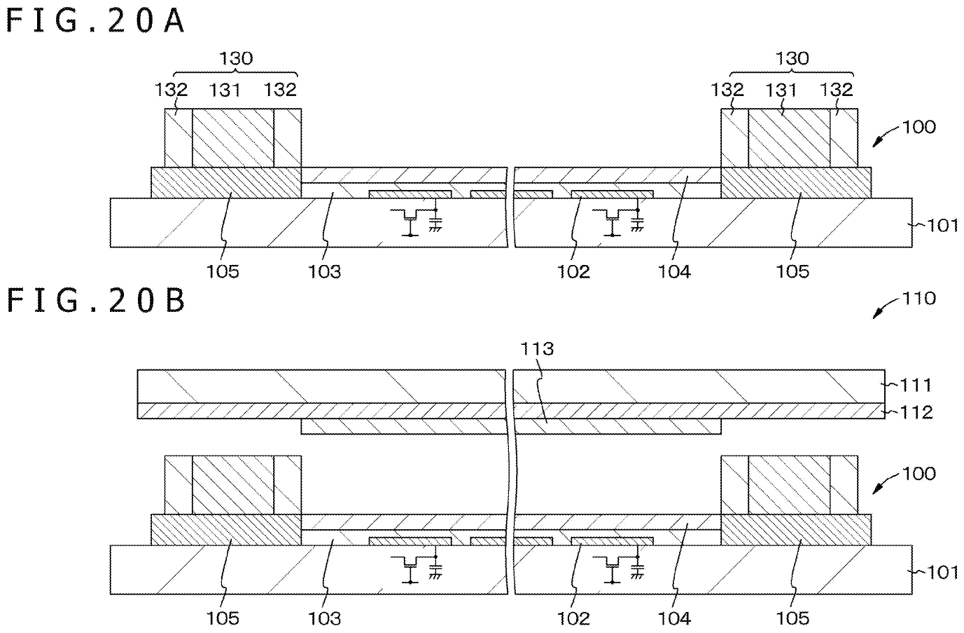

### [Step-250] (Refer to FIG. 20A)

Next, an oriented film 104 is formed on a part of the flattening film 103 surrounded by the sealing part 130. Through a series of steps described above, the back panel 100 formed with the sealing part 130 can be obtained.

### [Step-260] (Refer to FIG. 20B)

The front panel 110 formed with the counter electrode 112 and the oriented film 113 is provided. Next, in a state in which the front panel 110 and the back panel 100 are caused to face each other through the sealing part 130 (refer to FIG. 20B), for example, a surface of the connection electrode 105 and a surface of the facing sealing part 130 are activated under ultrahigh vacuum, and those surfaces are brought into close contact with each other, whereby the front panel 110 and the back panel 100 are bonded to each other. Subsequent steps are similar to the steps described with reference to FIG. 14A and FIG. 14B in the first embodiment, thereby omitting description.

Through a series of steps described above, the liquid crystal display element 1 can be obtained.

### Third Embodiment

In the embodiments described above, the description has been made in which the feeding electrode in the back panel is formed in the same layer as the pixel electrodes. However, for example, the drive circuits for driving the pixel electrodes are formed in the back panel. Accordingly, the feeding electrode can be formed in a different layer from the pixel electrodes. For example, the feeding electrode can be formed in the same layer as the wiring layer used for the drive circuits.

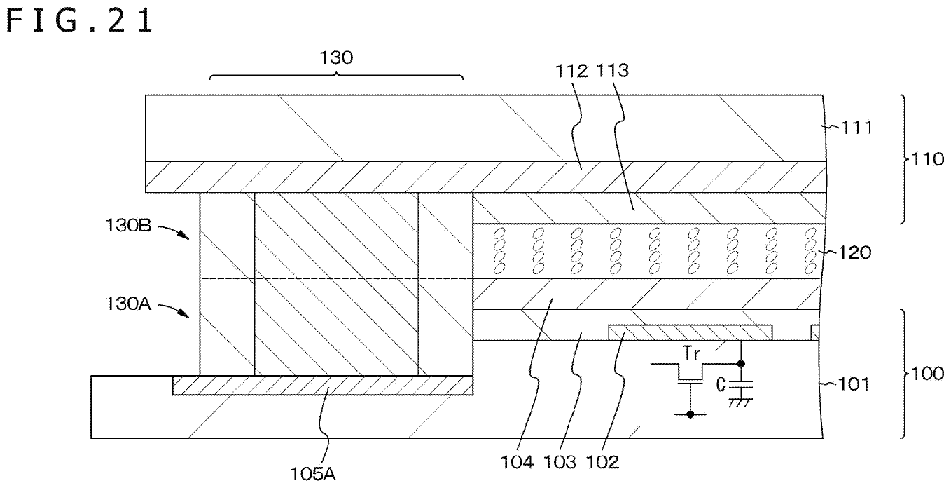

FIG. 21 is a schematic partial sectional view for explaining a structure of a sealing part between a front panel and a back panel in a liquid crystal display element according to a third embodiment.

A feeding electrode 105A is formed in the same layer as the wiring layer used for the drive circuits for driving the pixel electrodes 102.

Also in this configuration, similarly to the first embodiment and the second embodiment, it is possible to employ a step in which the sealing part 130 is formed on any one of the front panel and the back panel, and then the front panel and the back panel are bonded to each other.

However, in consideration of, for example, a difference produced by exposing the feeding electrode 105A, it is preferable to employ a step in which the sealing part 130 are partially formed on both the front panel 110 and the back panel, and then those are bonded to each other. In FIG. 21, a reference sign 130A indicates a part of the sealing part 130 provided on the back panel 100, and a reference sign 130B indicates a part of the sealing part 130 provided on the front panel 110.

Note that, although illustration is omitted, in a case where an electrode or the like is formed in a different layer from the counter electrode also on the front panel 110, it is possible to employ a configuration in which the electrode that is electrically conducted with the counter electrode and is provided in a different layer from the counter electrode is in contact with the sealing part.

In the above-described liquid crystal display element according to the present disclosure, the front panel and the back panel are electrically connected to each other through the sealing part surrounding the liquid crystal material layer. Accordingly, it is not necessary to secure a space for establishing electric conduction with the counter electrode in addition to the sealing part, whereby a bezel part can be decreased in size.

### [Explanation of Electronic Device]

The above-described liquid crystal display element according to the present disclosure can be used as a display unit (display device) of an electronic device in all fields, which displays a video signal input to the electronic device or a video signal generated in the electronic device as an image or a video. As an example, the liquid crystal display element can be used as a display unit in, for example, a television set, a digital still camera, a laptop-type personal computer, a portable terminal device such as a cellular phone, a video camera, and a head mounted display.

The display device of the present disclosure also includes a sealed configuration having a module shape. An example thereof is a display module formed such that a counter part such as transparent glass is bonded to a pixel array. Note that the display module may be provided with, for example, a circuit unit or a flexible printed circuit (FPC) for inputting and outputting a signal and the like between the outside and the pixel array. Hereinafter, a projection type display device, a digital still camera, and head mounted displays are exemplified as specific examples of the electronic device that uses the display device of the present disclosure. However, each specific example exemplified herein is merely an example, and the electronic device is not limited thereto.

### Specific Example 1

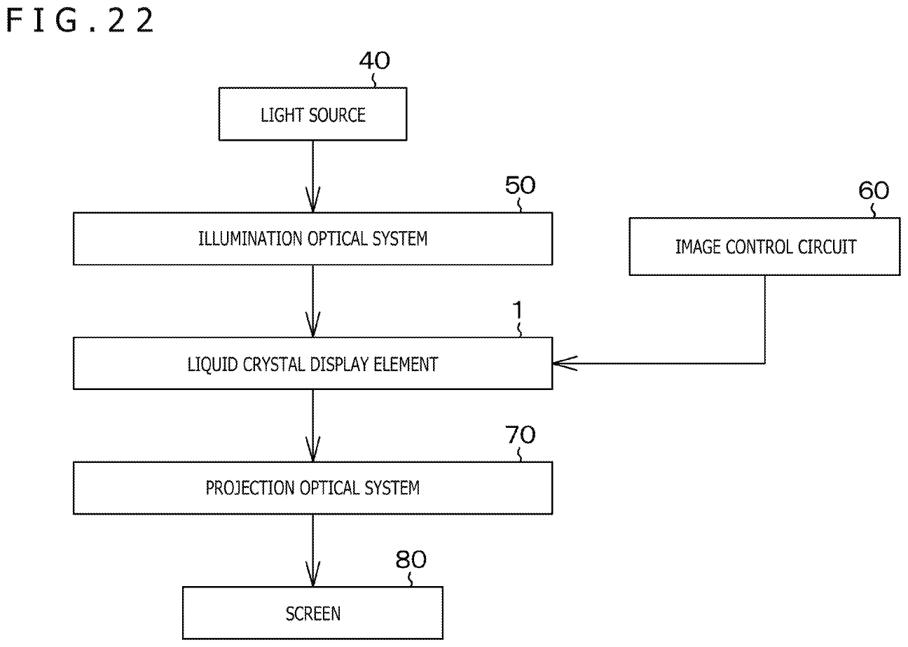

FIG. 22 is a conceptual view of a projection-type display device using the liquid crystal display element according to the present disclosure. The projection-type display device includes a light source 40, an illumination optical system 50, the liquid crystal display element 1, an image control circuit 60 for driving the liquid crystal display element, a projection optical system 70, and a screen 80, for example. The light source 40 can be configured with various types of lamps such as xenon lamps or semiconductor light emitting elements such as light emitting diodes, for example. The illumination optical system 50 is used to guide light from the light source 40 to the liquid crystal display element 1, and is configured with optical elements such as a prism and a dichroic mirror. The liquid crystal display element 1 acts as a light valve, and an image is projected on the screen 80 via the projection optical system 70.

### Specific Example 2

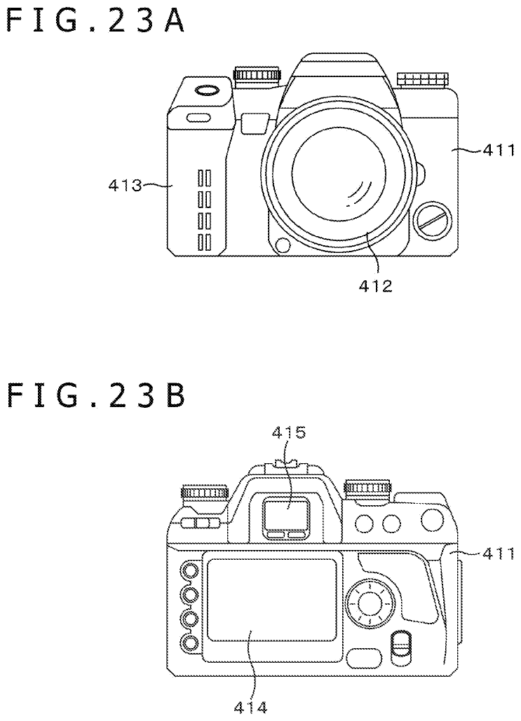

FIG. 23 illustrates an external appearance view of a digital still camera of a lens interchangeable single lens reflex type, FIG. 23A illustrates a front view of this camera, and FIG. 23B illustrates a rear view of this camera. The digital still camera of the lens interchangeable single lens reflex type includes an interchangeable photographing lens unit (interchangeable lens) 412 on the front right side of a camera body unit (camera body) 411, and includes a grip unit 413 on the front left side thereof, for example.

A monitor 414 is provided at a substantially center of a rear surface of the camera body unit 411. A view finder (ocular window) 415 is provided above the monitor 414. A photographer looks in the view finder 415, whereby an optical image of a subject introduced from the photographing lens unit 412 can be visually recognized, and composition can be determined.

In the digital still camera of the lens interchangeable single lens reflex type having the above-described configuration, the display device of the present disclosure can be used as the view finder 415. In other words, the digital still camera of the lens interchangeable single lens reflex type according to this example is produced using the display device of the present disclosure as the view finder 415.

### Specific Example 3

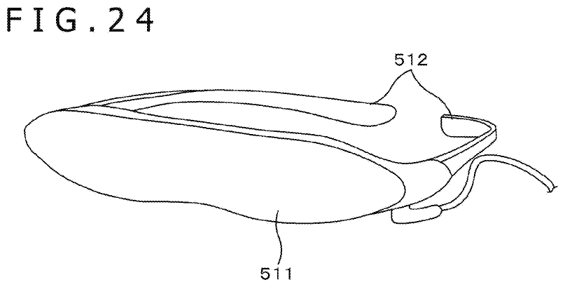

FIG. 24 is an external appearance view of a head mounted display. The head mounted display includes ear hooking parts 512 to be mounted on a head of a user, on both sides of a spectacle-shaped display unit 511. In this head mounted display, the display device of the present disclosure can be used as the display unit 511. In other words, the head mounted display according to this example is produced using the display device of the present disclosure as the display unit 511.

### Specific Example 4

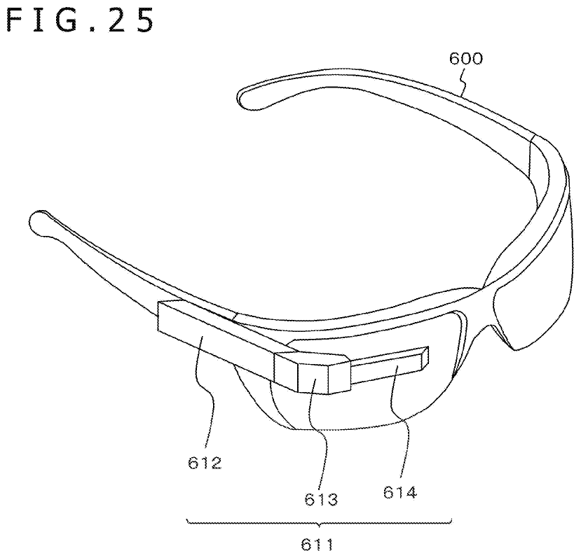

FIG. 25 is an external appearance view of a see-through head mounted display. A see-through head mounted display 611 is configured with a body unit 612, an arm 613, and a lens barrel 614.

The body unit 612 is connected to the arm 613 and a spectacle 600. Specifically, an end part of the body unit 612 in a long side direction is combined with the arm 613, and one side of side surfaces of the body unit 612 is coupled to the spectacle 600 through a connection member. Note that the body unit 612 may directly be mounted on a head of a human body.

The body unit 612 includes a control board for controlling an operation of the see-through head mounted display 611, and a display unit. The arm 613 causes the body unit 612 and the lens barrel 614 to be connected to each other, and supports the lens barrel 614. Specifically, the arm 613 is combined with the end part of the body unit 612 and an end part of the lens barrel 614, to fix the lens barrel 614. Furthermore, the arm 613 includes a signal line for communication of data related to an image provided to the lens barrel 614 from the body unit 612.

The lens barrel 614 projects light of the image provided from the body unit 612 through the arm 613 toward an eye of the user mounting the see-through head mounted display 611 through an ocular lens. In the see-through head mounted display 611, the display device of the present disclosure can be used as the display unit of the body unit 612.

### [Others]

It should be noted that the technique of the present disclosure can employ the following configurations.

### [A1]

A liquid crystal display element including:

a front panel;

a back panel disposed facing the front panel;

a liquid crystal material layer held between the front panel and the back panel; and

a sealing part provided at a position surrounding a periphery of the liquid crystal material layer and establishing electric connection between the front panel and the back panel.

### [A2]

The liquid crystal display element according to above-described [A1], in which

the sealing part is configured with
a conductive film whose upper surface side is in contact with the front panel and whose lower surface side is in contact with the back panel, and
an insulating film that covers an end surface of the conductive film.

### [A3]

The liquid crystal display element according to above-described [A2], in which

the front panel is provided with a counter electrode including a transparent conductive material, and

the conductive film configuring the sealing part is disposed to cause an upper surface side of the conductive film to be electrically conducted with the counter electrode.

### [A4]

The liquid crystal display element according to above-described [A2] or [A3], in which

a feeding electrode that supplies a voltage to the counter electrode is disposed on a surface of the back panel, facing the liquid crystal material layer, and

the conductive film configuring the sealing part is disposed to cause a lower surface side of the conductive film to be electrically conducted with the feeding electrode.

### [A5]

The liquid crystal display element according to above-described [A4], in which

a pixel electrode is disposed on the surface of the back panel, facing the liquid crystal material layer, and

the feeding electrode is formed in the same layer as the pixel electrode.

### [A6]

The liquid crystal display element according to above-described [A4], in which

a pixel electrode is disposed on the surface of the back panel, facing the liquid crystal material layer, and

the feeding electrode is formed in a different layer from the pixel electrode.

### [A7]

The liquid crystal display element according to above-described [A6], in which

a drive circuit for driving the pixel electrode is formed in the back panel, and

the feeding electrode is formed in the same layer as a wiring layer used for the drive circuit.

[A8]

The liquid crystal display element according to any one of above-described [A2] to [A7], in which

the conductive film configuring the sealing part is configured with a metal material.

### [A9]

The liquid crystal display element according to any one of above-described [A2] to [A8], in which

the insulating film configuring the sealing part is configured with an inorganic insulating material.

### [B1]

A manufacturing method of a liquid crystal display element including

a front panel,

a back panel disposed facing the front panel, and

a liquid crystal material layer held between the front panel and the back panel, the manufacturing method including:

a step of forming a sealing part provided at a position surrounding a periphery of the liquid crystal material layer and establishing electric connection between the front panel and the back panel, on at least one of the front panel or the back panel; and

a step of bonding the front panel and the back panel to each other through the sealing part.

### [B2]

The manufacturing method of the liquid crystal display element according to above-described [B1], in which

the sealing part is configured with
a conductive film whose upper surface side is in contact with the front panel and whose lower surface side is in contact with the back panel, and
an insulating film that covers an end surface of the conductive film.

### [B3]

The manufacturing method of the liquid crystal display element according to above-described [B2], in which

the front panel is provided with a counter electrode including a transparent conductive material, and

the conductive film configuring the sealing part is disposed to cause an upper surface side of the conductive film to be electrically conducted with the counter electrode.

### [B4]

The manufacturing method of the liquid crystal display element according to above-described [B2] or [B3], in which

a feeding electrode that supplies a voltage to the counter electrode is disposed on a surface of the back panel, facing the liquid crystal material layer, and

the conductive film configuring the sealing part is disposed to cause a lower surface side of the conductive film to be electrically conducted with the feeding electrode.

### [B5]

The manufacturing method of the liquid crystal display element according to above-described [B4], in which

a pixel electrode is disposed on the surface of the back panel, facing the liquid crystal material layer, and

the feeding electrode is formed in the same layer as the pixel electrode.

### [B6]

The manufacturing method of the liquid crystal display element according to above-described [B4], in which

a pixel electrode is disposed on the surface of the back panel, facing the liquid crystal material layer, and

the feeding electrode is formed in a different layer from the pixel electrode.

### [B7]

The manufacturing method of the liquid crystal display element according to above-described [B6], in which

a drive circuit for driving the pixel electrode is formed in the back panel, and

the feeding electrode is formed in the same layer as a wiring layer used for the drive circuit.

### [B8]

The manufacturing method of the liquid crystal display element according to any one of above-described [B2] to [B7], in which

the conductive film configuring the sealing part is configured with a metal material.

### [B9]

The manufacturing method of the liquid crystal display element according to any one of above-described [B2] to [B8], in which

the insulating film configuring the sealing part is configured with an inorganic insulating material.

### [C1]

An electronic device including:

a liquid crystal display element including
a front panel,
a back panel disposed facing the front panel,
a liquid crystal material layer held between the front panel and the back panel, and
a sealing part that surrounds a periphery of the liquid crystal material layer, and establishes electric connection between the front panel and the back panel.

### [C2]

The electronic device according to above-described [C1], in which

the sealing part is configured with
a conductive film whose upper surface side is in contact with the front panel and whose lower surface side is in contact with the back panel, and
an insulating film that covers an end surface of the conductive film.

### [C3]

The electronic device according to above-described [C2], in which

the front panel is provided with a counter electrode including a transparent conductive material, and

the conductive film configuring the sealing part is disposed to cause an upper surface side of the conductive film to be electrically conducted with the counter electrode.

### [C4]

The electronic device according to above-described [C2] or [C3], in which

a feeding electrode that supplies a voltage to the counter electrode is disposed on a surface of the back panel, facing the liquid crystal material layer, and

the conductive film configuring the sealing part is disposed to cause a lower surface side of the conductive film to be electrically conducted with the feeding electrode.

### [C5]

The electronic device according to above-described [C4], in which

a pixel electrode is disposed on the surface of the back panel, facing the liquid crystal material layer, and

the feeding electrode is formed in the same layer as the pixel electrode.

### [C6]

The electronic device according to above-described [C4], in which

a pixel electrode is disposed on the surface of the back panel, facing the liquid crystal material layer, and

the feeding electrode is formed in a different layer from the pixel electrode.

### [C7]

The electronic device according to above-described [C6], in which

a drive circuit for driving the pixel electrode is formed in the back panel, and

the feeding electrode is formed in the same layer as a wiring layer used for the drive circuit.

### [C8]

The electronic device according to any one of above-described [C2] to [C7], in which

the conductive film configuring the sealing part is configured with a metal material.

### [C9]

The electronic device according to any one of above-described [C2] to [C8], in which

the insulating film configuring the sealing part is configured with an inorganic insulating material.

### REFERENCE SIGNS LIST

1 Liquid crystal display element, 10 Pixel array, 11 Pixel, 20 Horizontal drive circuit, 30 Vertical drive circuit, 40 Light source, 50 Illumination optical system, 60 Image control circuit, 70 Projection optical system, 80 Screen, 100 Back panel, 101 Substrate, 102 Pixel electrode, 103 Flattening film, 104 Oriented film, 105, 105A Feeding electrode, 106, 107 Mask layer, 110 Front panel, 111 Substrate, 112 Counter electrode, 113 Oriented film, 114, 115 Mask layer, 120 Liquid crystal material layer, 130 Sealing part, 131 Conductive film, 131A, 131B Conductive material layer, 132, 132A, 132B Insulating film, 132C, 132D Insulating material layer, 411 Camera body unit, 412 Photographing lens unit, 413 Grip unit, 414 Monitor, 415 View finder, 511 Spectacle-shaped display unit, 512 Ear hooking part, 600 Spectacle, 611 See-through head mounted display, 612 Body unit, 613 Arm, 614 Lens barrel

1. A liquid crystal display element comprising:
a front panel;
a back panel disposed facing the front panel;
a liquid crystal material layer held between the front panel and the back panel; and
a sealing part provided at a position surrounding a periphery of the liquid crystal material layer and establishing electric connection between the front panel and the back panel.

2. The liquid crystal display element according to claim 1, wherein
the sealing part is configured with
a conductive film whose upper surface side is in contact with the front panel and whose lower surface side is in contact with the back panel, and
an insulating film that covers an end surface of the conductive film.

3. The liquid crystal display element according to claim 2, wherein
the front panel is provided with a counter electrode including a transparent conductive material, and
the conductive film configuring the sealing part is disposed to cause an upper surface side of the conductive film to be electrically conducted with the counter electrode.

4. The liquid crystal display element according to claim 2, wherein
a feeding electrode that supplies a voltage to the counter electrode is disposed on a surface of the back panel, facing the liquid crystal material layer, and
the conductive film configuring the sealing part is disposed to cause a lower surface side of the conductive film to be electrically conducted with the feeding electrode.

5. The liquid crystal display element according to claim 4, wherein
a pixel electrode is disposed on the surface of the back panel, facing the liquid crystal material layer, and
the feeding electrode is formed in a same layer as the pixel electrode.

6. The liquid crystal display element according to claim 4, wherein
a pixel electrode is disposed on the surface of the back panel, facing the liquid crystal material layer, and
the feeding electrode is formed in a different layer from the pixel electrode.

7. The liquid crystal display element according to claim 6, wherein
a drive circuit for driving the pixel electrode is formed in the back panel, and
the feeding electrode is formed in a same layer as a wiring layer used for the drive circuit.

8. The liquid crystal display element according to claim 2, wherein
the conductive film configuring the sealing part is configured with a metal material.

9. The liquid crystal display element according to claim 2, wherein
the insulating film configuring the sealing part is configured with an inorganic insulating material.

10. The liquid crystal display element according to claim 1, wherein
an opening for injecting a liquid crystal material is formed in the sealing part.

11. A manufacturing method of a liquid crystal display element including
a front panel,
a back panel disposed facing the front panel, and
a liquid crystal material layer held between the front panel and the back panel, the manufacturing method comprising:
a step of forming a sealing part provided at a position surrounding a periphery of the liquid crystal material layer and establishing electric connection between the front panel and the back panel, on at least one of the front panel or the back panel; and
a step of bonding the front panel and the back panel to each other through the sealing part.

12. The manufacturing method of the liquid crystal display element according to claim 11, wherein
the sealing part is configured with
a conductive film whose upper surface side is in contact with the front panel and whose lower surface side is in contact with the back panel, and
an insulating film that covers an end surface of the conductive film.

13. An electronic device comprising:
a liquid crystal display element including
a front panel,
a back panel disposed facing the front panel,
a liquid crystal material layer held between the front panel and the back panel, and
a sealing part that surrounds a periphery of the liquid crystal material layer and establishes electric connection between the front panel and the back panel.

14. The electronic device according to claim 13, wherein
the sealing part is configured with
a conductive film whose upper surface side is in contact with the front panel and whose lower surface side is in contact with the back panel, and
an insulating film that covers an end surface of the conductive film.
